(19) United States
(12) Patent Application Publication
(10) Pub. No.: US 2024/0316575 A1
(43) Pub. Date: Sep. 26, 2024

(54) AUTO-SWINGING SHOWER

(71) Applicant: Xiamen Galenpoo Kitchen&Bathroom Technology Co., Ltd, Fujian (CN)

(72) Inventor: Xiaoling YAN, Fujian (CN)

(21) Appl. No.: 18/732,641

(22) Filed: Jun. 4, 2024

(51) Int. Cl. B05B 1/18; B05B 3/04

(52) U.S. Cl. CPC B05B 1/185; B05B 3/0422

(57) ABSTRACT

An auto-swinging shower which drives a water outlet assembly to swing without external power, containing a water flow-through part, a water outlet assembly, an impeller and a transmission assembly. The water flow-through part is provided with a water flow-through cavity. A water inlet end of the water outlet assembly is pivotally engaged with a water outlet end of the water flow-through part and communicates with the water flow-through cavity. The impeller is rotatably engaged in the water flow-through cavity. An input end of the transmission assembly is in transmission connection to a rotating shaft of the impeller. An output end of the transmission assembly is in transmission connection to the water outlet assembly.

### BACKGROUND OF THE INVENTION

The present invention relates to the technical field of sanitary and bathroom devices, and in particular, to an auto-swinging shower.

The current rainfall shower head is usually mounted at the top of a shower bar through a ball joint, a user can adjust the water outlet direction by moving a shower body, but the adjusted water outlet direction is fixed and does not change any more, namely the rainfall shower head discharges water towards a single direction all the time, with a small water outlet range and a single water outlet mode, failing to meet diversified user requirements.

Therefore, it is necessary to design a mechanism for the rainfall shower head to be able to drive it to rotate or swing. In the prior art, a mechanical structure specifically driving the shower body needs to be designed between the shower bar and the exterior of the rainfall shower head, and an external energy source is also needed to provide power for the mechanical structure, which is usually electric power, posing potential safety hazards. Moreover, such design also complicates the mounting structure of the rainfall shower head, increasing the cost.

### BRIEF SUMMARY OF THE INVENTION

The present invention aims to provide an auto-swinging shower to solve the problems in the prior art, which can drive a water outlet assembly to swing without external power, and achieve a large-angle water outlet range with real-time changes.

To attain the above objects, the present invention provides the following technical solutions:

An auto-swinging shower comprising a water flow-through part, a water outlet assembly, an impeller and a transmission assembly; the water flow-through part is provided with a water flow-through cavity; a water inlet end of the water outlet assembly is pivotally engaged with a water outlet end of the water flow-through part and communicates with the water flow-through cavity; the impeller is rotatably engaged in the water flow-through cavity; an input end of the transmission assembly is in transmission connection to a rotating shaft of the impeller; an output end of the transmission assembly is in transmission connection to the water outlet assembly for driving the water outlet assembly to swing around a pivot shaft between the water outlet assembly and the water flow-through part.

The transmission assembly comprises a gear fixing plate, a gear shaft, a gear cover, and an output gear; the gear fixing plate is fixedly connected to the water flow-through part and seals a side opening of the water flow-through cavity; the gear shaft is movably and sealingly arranged on the gear fixing plate in a penetrating manner and is in key connection to the impeller; the gear cover is arranged parallel to the gear fixing plate and is fixedly connected to the gear fixing plate; the output gear is rotatably engaged between the gear fixing plate and the gear cover and is in transmission connection to the gear shaft; a transmission rod is arranged on the output gear; a protrusion is arranged on the water outlet assembly at a side of the output gear; a stadium-shaped hole is formed on the protrusion, and the transmission rod is movably engaged in the stadium-shaped hole.

Preferably, the transmission assembly further comprises a plurality of transmission gears arranged between the gear fixing plate and the gear cover and in transmission connection between the gear shaft and the output gear.

Preferably, the protrusion is a block-shaped part independently mounted on an upper surface of the water outlet assembly.

Preferably, a convex ring is formed on a surface of the gear fixing plate facing the water flow-through part; the convex ring is embedded in the side opening of the water flow-through cavity, and a sealing ring is provided between a circumferential surface of the convex ring and an inner wall of the side opening; a V-ring is provided between the gear fixing plate and the gear shaft.

Preferably, a notch is formed on the gear cover for movable engagement of the transmission rod.

The auto-swinging shower further comprises a control assembly; the control assembly comprises a button fixing seat, a button, a rotation stopping pin, and a reset spring; a rotation stopping protrusion is arranged on an end surface of the impeller; the button fixing seat is relatively fixed with the water flow-through part and is provided with a moving channel; the button is telescopically engaged at an outer end portion of the moving channel; the rotation stopping pin is engaged in an inner end portion of the moving channel in an axially movable manner, and movably and sealingly penetrates into the water flow-through cavity and abuts against the end surface of the impeller; as the impeller rotates, the rotation stopping pin movably abuts against a side surface of the rotation stopping protrusion; the reset spring drives the rotation stopping pin to move in a direction away from the impeller; a click-pen mechanism is arranged among the button fixing seat, the button and the rotation stopping pin.

Preferably, an upper surface of the rotation stopping protrusion is an inclined surface, and the inclined surface is inclined towards the end surface of the impeller along a circumferential direction of the impeller.

Preferably, an inner wall of the moving channel is repeatedly provided with a plurality of sets of structures, with each set of structures comprising a long groove, a short groove and a first unidirectional tooth; a circumferential surface of the button is provided with guiding protrusions which are slidably engaged in the long grooves, and an end surface of the button facing the rotation stopping pin is provided with a plurality of bidirectional teeth; a circumferential surface of the rotation stopping pin is provided with limiting protrusions which are slidably engaged in the long grooves or the short grooves, and an end surface of the rotation stopping pin facing the button is provided with a plurality of second unidirectional teeth which are arranged at equal angular intervals; the click-pen mechanism is formed by the long grooves, the short grooves, the first unidirectional teeth, the guiding protrusions, the bidirectional teeth, the limiting protrusions and the second unidirectional teeth.

Preferably, the rotation stopping pin is composed of a pin shaft and a movable part which are designed separately; the limiting protrusions and the second unidirectional teeth are both arranged on the movable part; a limiting plate is arranged on an end portion of the pin shaft opposite to the movable member, and the movable part and the reset spring are located on two sides of the limiting plate respectively.

Preferably, a circular gasket is arranged on an inner end of the moving channel, and the rotation stopping pin penetrates through the circular gasket into the water flow-through cavity.

The water flow-through part comprises a water inlet body and a water outlet body which are designed separately; the water flow-through cavity is arranged in the water inlet body; a lower end of the water outlet body is provided with a rotating shaft and a water outlet pipe which are coaxially arranged; two sides of an upper surface of the water outlet assembly are rotatably engaged on the rotating shaft and the water outlet pipe respectively, and two ends of the water outlet pipe communicate with the water flow-through cavity and the water outlet assembly.

Due to the technical solutions mentioned above, the present invention has the following technical effects:

In the present invention, the impeller and the transmission assembly are arranged at the water flow-through part, and the water outlet assembly is pivoted at the water outlet end of the water flow-through part; when water enters the water flow-through part, the impeller is driven by water flow to rotate, thereby generating power and transmitting the power to the transmission assembly, and the transmission assembly drives the water outlet assembly to swing, thereby achieving the auto-swing of the water outlet assembly. In the present invention, the auto-swing of the water outlet assembly can be achieved as long as water enters, and the water outlet assembly can have a large-angle water outlet range with real-time changes without providing external power, thereby meeting the requirements of some users.

### BRIEF DESCRIPTION OF THE DRAWINGS

FIG. 1 is a perspective view of a specific embodiment according to the present invention;

FIG. 2 is a perspective view of a partial structure of a specific embodiment according to the present invention (without a housing);

FIG. 3 is an exploded view of a partial structure of a specific embodiment according to the present invention (without a housing);

FIG. 4 is an exploded view of a water flow-through part of a specific embodiment according to the present invention;

FIG. 5 is an exploded view of a control assembly of a specific embodiment according to the present invention;

FIG. 6 is a perspective view of a button fixing seat of a specific embodiment according to the present invention;

FIG. 7 is a front view of a specific embodiment according to the present invention;

FIG. 8 is a cross-sectional view taken along the direction of A-A in FIG. 7;

FIG. 9 is a cross-sectional view taken along the direction of C-C in FIG. 8;

FIG. 10 is a cross-sectional view taken along the direction of B-B in FIG. 7; and

FIG. 11 is a schematic view illustrating the swing of a water outlet assembly of a specific embodiment according to the present invention.

### DETAILED DESCRIPTION OF THE INVENTION

To further explain the technical solutions of the present invention, a detailed description of the present invention is provided below through specific embodiments.

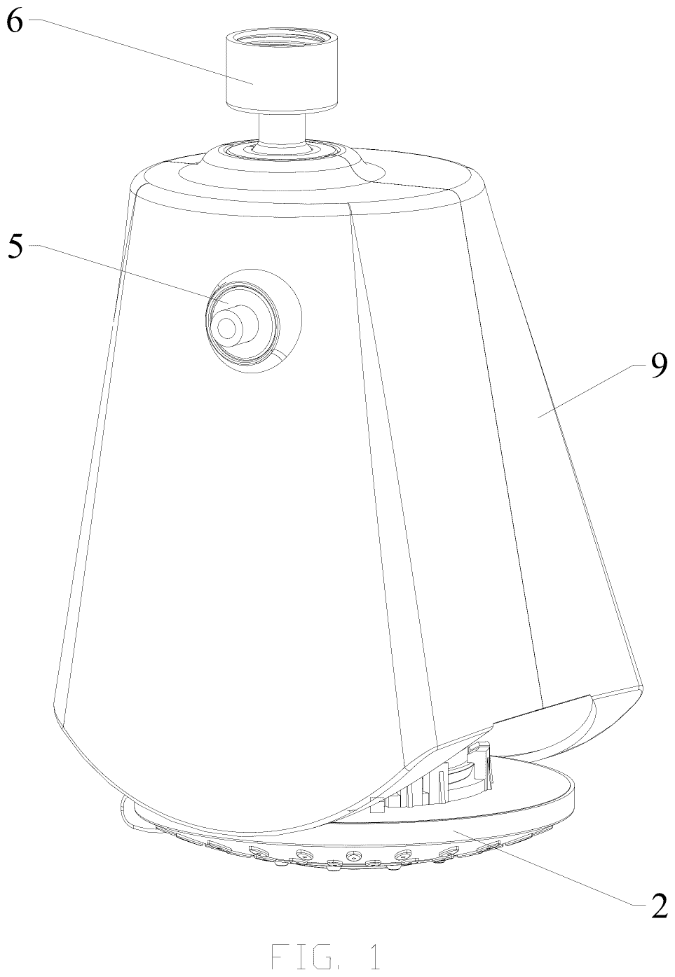

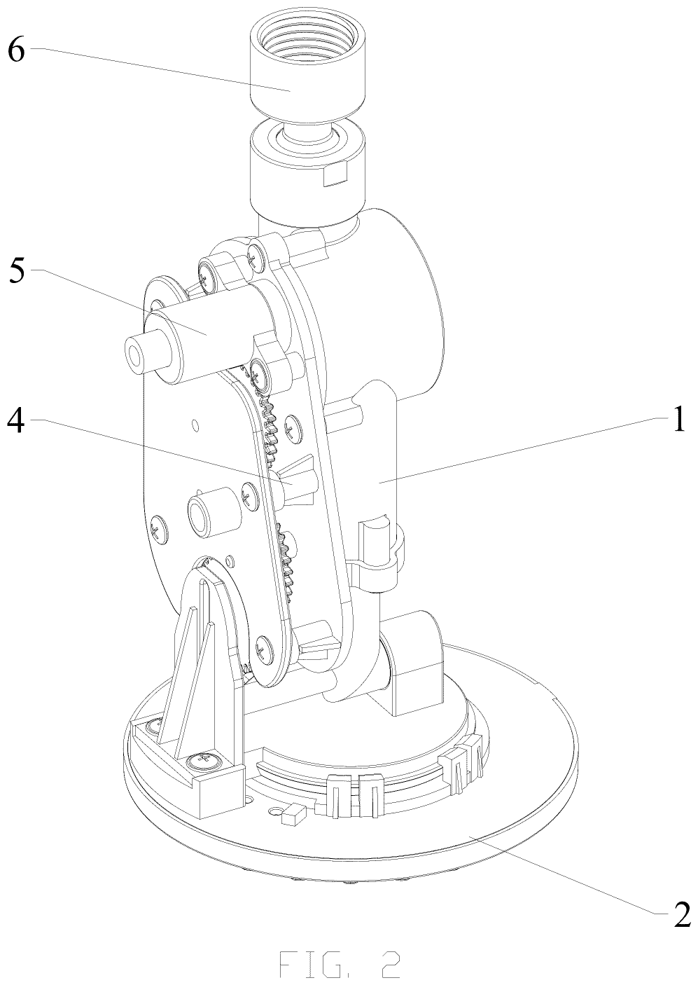

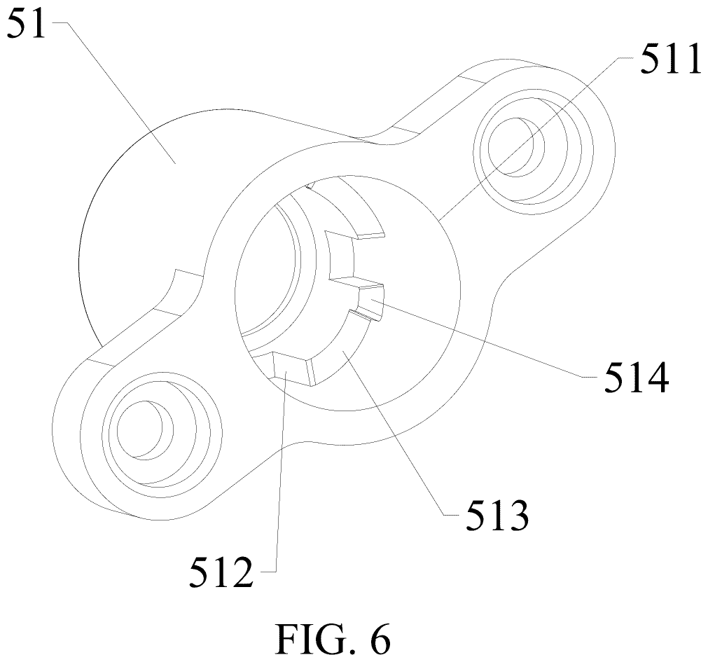

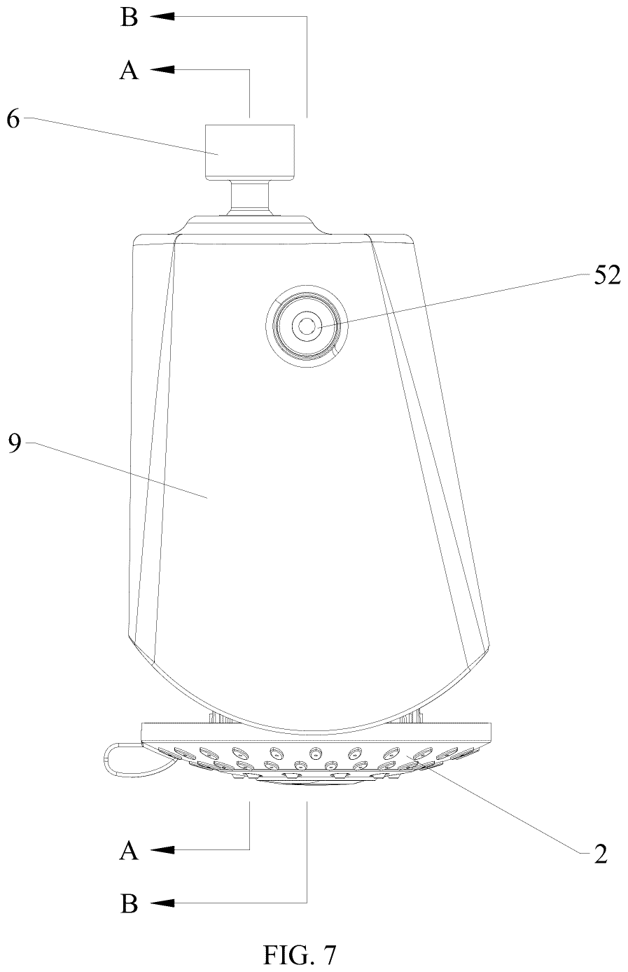

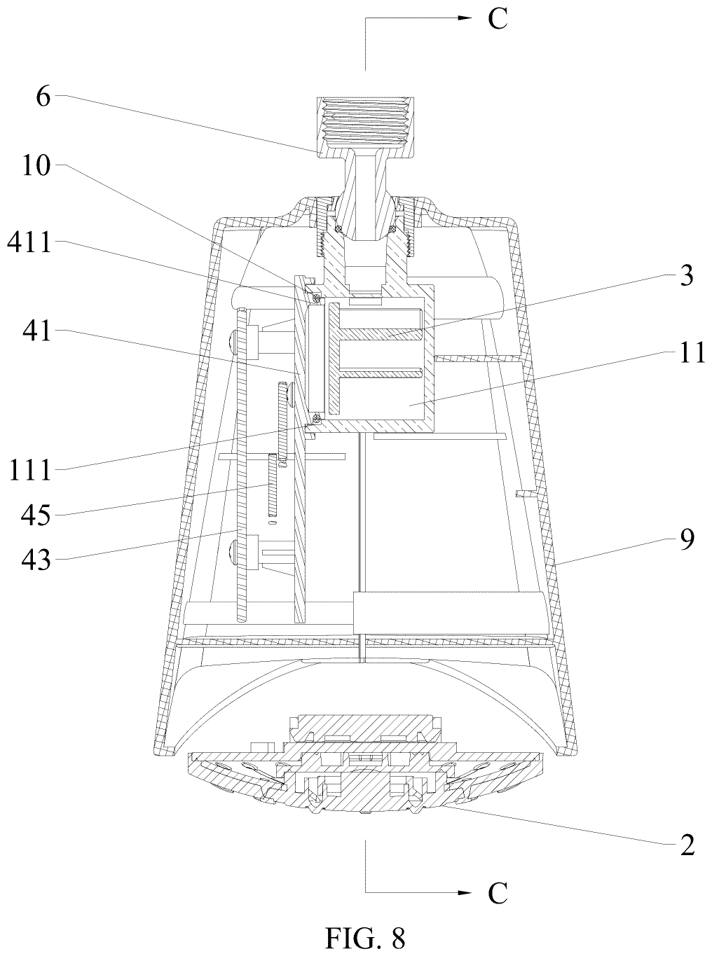

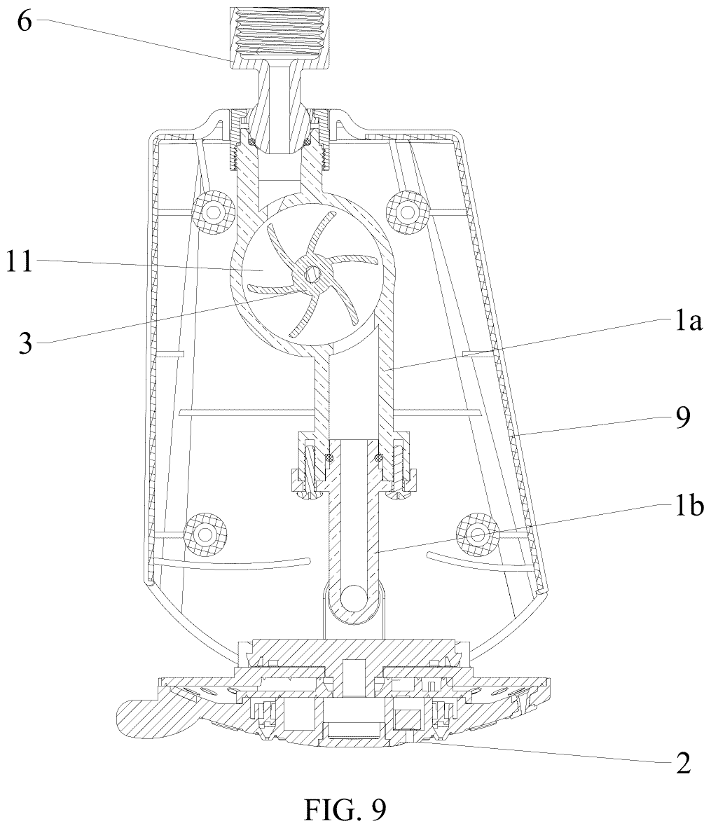

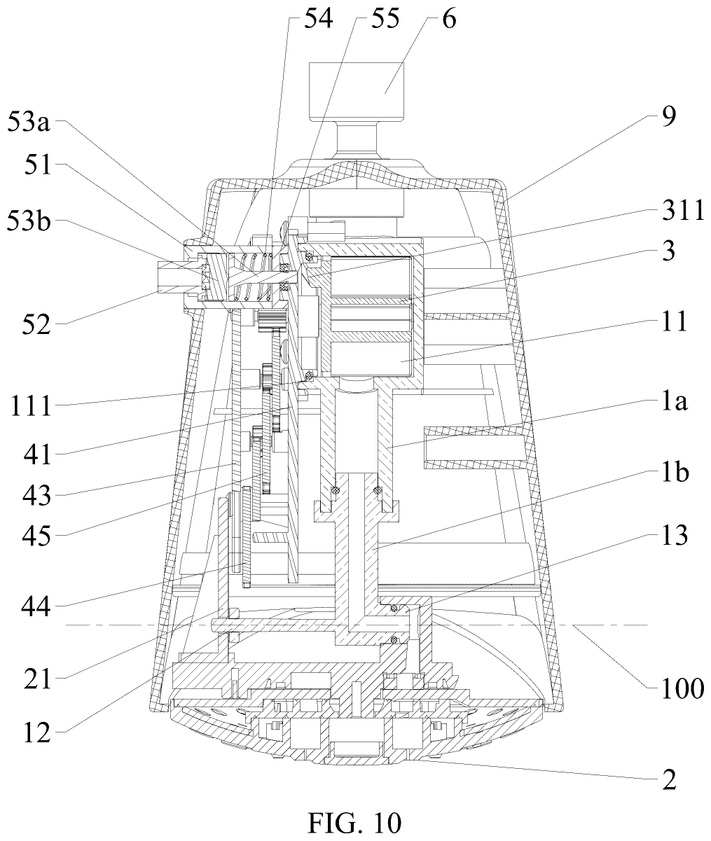

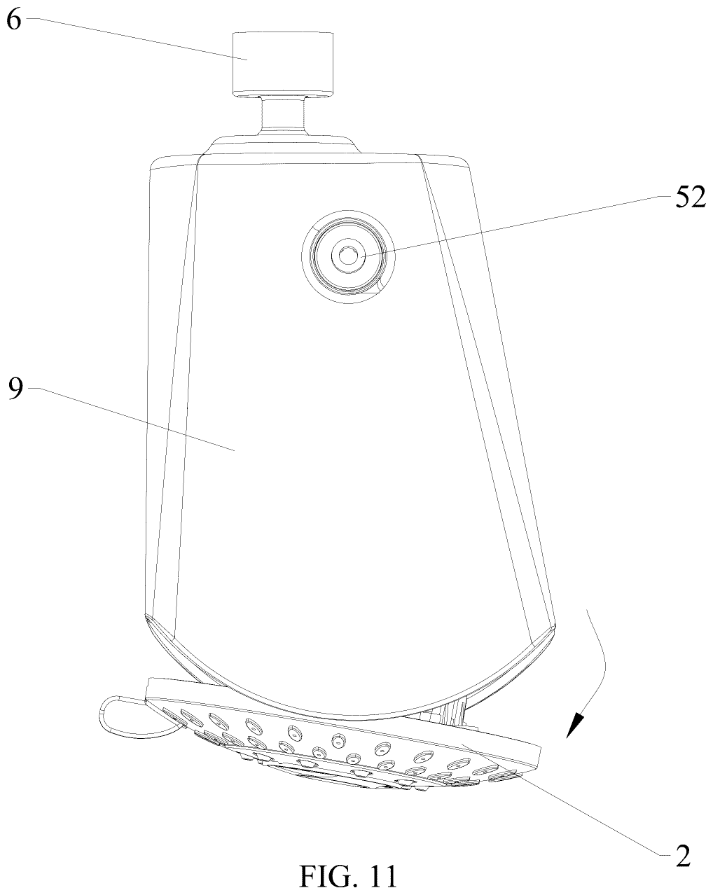

Referring to FIGS. 1 to 11, the present invention discloses an auto-swinging shower, which comprises a water flow-through part 1, a water outlet assembly 2, an impeller 3, and a transmission assembly 4;
the water flow-through part 1 is provided with a water flow-through cavity 11;
a water inlet end of the water outlet assembly 2 is pivotally engaged with a water outlet end of the water flow-through part 1 and communicates with the water flow-through cavity 11;
the impeller 3 is rotatably engaged in the water flow-through cavity 11;
the transmission assembly 4 may be arranged on a surface of or inside the water flow-through part 1 according to an actual design of a product; an input end of the transmission assembly 4 is in transmission connection to a rotating shaft of the impeller 3; and an output end of the transmission assembly 4 is in transmission connection to the water outlet assembly 2 for driving the water outlet assembly 2 to swing around a pivot shaft 100 between the water outlet assembly 2 and the water flow-through part 1 (see FIG. 11).

According to the above solutions, the present invention achieves the auto-swing of the water outlet assembly 2 through the following configuration: the impeller 3 and the transmission assembly 4 are arranged at the water flow-through part 1, and the water outlet assembly 2 is pivoted at the water outlet end of the water flow-through part 1; when water enters the water flow-through part 1, the impeller 3 is driven by water flow to rotate, thereby generating power and transmitting the power to the transmission assembly 4, and the transmission assembly 4 drives the water outlet assembly 2 to swing. In the present invention, the auto-swing of the water outlet assembly 2 can be achieved as long as water enters, and the water outlet assembly 2 can have a large-angle water outlet range with real-time changes without providing external power, thereby meeting the requirements of some users.

The following describes the specific embodiments of the present invention.

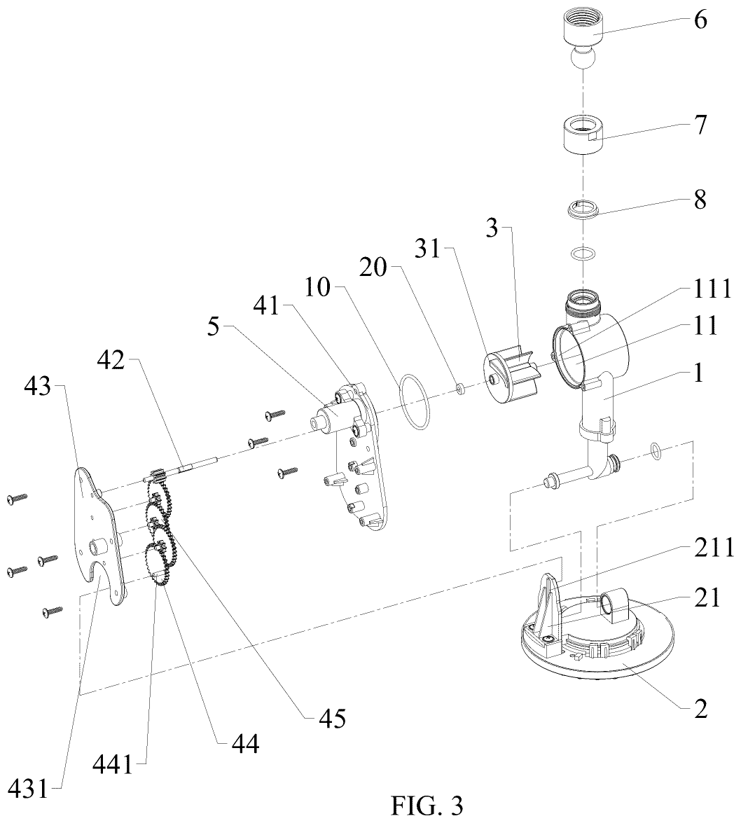

Referring to FIG. 3, the transmission assembly 4 comprises a gear fixing plate 41, a gear shaft 42, a gear cover 43, and an output gear 44. The gear fixing plate 41 is fixedly connected to the water flow-through part 1 in a screw locking manner and the like, and seals a side opening 111 of the water flow-through cavity 11; the gear shaft 42 is movably and sealingly arranged on the gear fixing plate 41 in a penetrating manner and is in key connection to the impeller 3 to achieve synchronous rotation; the gear cover 43 is arranged parallel to the gear fixing plate 41 and is fixedly connected to the gear fixing plate 41 in a screw locking manner and the like; the output gear 44 is rotatably engaged between the gear fixing plate 41 and the gear cover 43 and is in transmission connection to the gear shaft 42; a transmission rod 441 is arranged on the output gear 44; and a protrusion 21 is arranged on the water outlet assembly 2 at a side of the output gear 44, a stadium-shaped hole 211 is formed on the protrusion 21, and the transmission rod 441 is movably engaged in the stadium-shaped hole 211, such that the rotation of the output gear 44 can drive the water outlet assembly 2 to swing left and right.

Further, the transmission assembly 4 further comprises a plurality of transmission gears 45 arranged between the gear fixing plate 41 and the gear cover 43 and in transmission connection between the gear shaft 42 and the output gear 44. By providing different numbers of the transmission gears 45 and different gears of the transmission gears 45, the transmission ratio between the gear shaft 42 and the output gear 44 can be changed, thereby achieving a decelerated transmission and increasing a torque force output by the transmission assembly 4.

At the same time, the protrusion 21 is a block-shaped part independently mounted on an upper surface of the water outlet assembly 2, that is, the protrusion 21 is detachably connected to the water outlet assembly 2, and the protrusion 21 with different stadium-shaped holes 211 can be replaced according to the design requirements of the product to control and adjust the swinging angle.

Besides, a convex ring 411 is formed on a surface of the gear fixing plate 41 facing the water flow-through part 1, the convex ring 411 is embedded in the side opening 111 of the water flow-through cavity 11, and a sealing ring 10 is provided between a circumferential surface of the convex ring 411 and an inner wall of the side opening 111, such that the gear fixing plate 41 fixedly seals the water flow-through cavity 11; a V-ring 20 is provided between the gear fixing plate 41 and the gear shaft 42 to achieve movable sealing between the gear fixing plate 41 and the gear shaft 42.

At last, a notch 431 is formed on the gear cover 43 for movable engagement of the transmission rod 441 to give way to the circular movement of the transmission rod 441 and avoid interference.

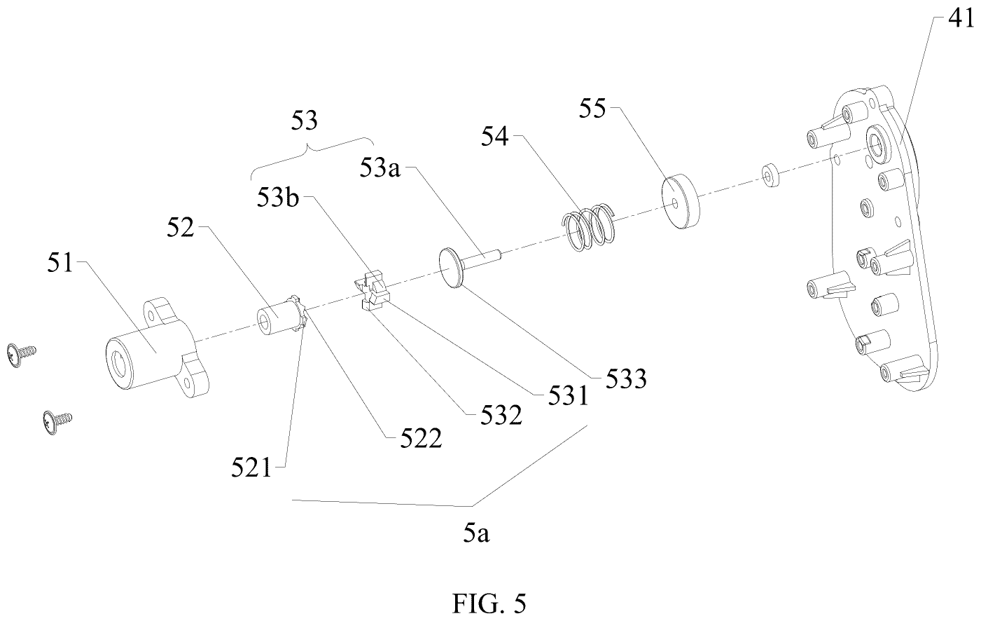

The present invention further comprises a control assembly 5; referring to FIG. 5, the control assembly 5 comprises a button fixing seat 51, a button 52, a rotation stopping pin 53, and a reset spring 54; a rotation stopping protrusion 31 is arranged on an end surface of the impeller 3; the button fixing seat 51 is relatively fixed with the water flow-through part 1 and is provided with a moving channel 511; the button 52 is telescopically engaged at an outer end portion of the moving channel 511; the rotation stopping pin 53 is engaged in the moving channel 511 in an axially movable manner, and movably and sealingly penetrates into the water flow-through cavity 11 and abuts against the end surface of the impeller 3; as the impeller 3 rotates, the rotation stopping pin 53 movably abuts against a side surface of the rotation stopping protrusion 31 to limit rotation of the impeller 3; the reset spring 54 is used for driving the rotation stopping pin 53 to move in a direction away from the impeller 3 to release the limitation of the rotation stopping pin 53 on the impeller 3; a click-pen mechanism 5a is arranged among the button fixing seat 51, the button 52 and the rotation stopping pin 53; the click-pen mechanism 5a is a mechanism commonly found in retractable ball-point pen, such that each time the button 52 is pressed down, the rotation stopping pin 53 is driven to rotate and an axial position of the rotation stopping pin 53 in the moving channel 511 is changed, thereby resulting in the rotation stopping pin 53 being extended to abut against the end surface of the impeller 3 or being retracted to separate from the end surface of the impeller 3. The control assembly 5 can control whether the rotation stopping pin 53 limits the rotation of the impeller 3 through the action of a user pressing the button 52, thereby controlling the swinging of the water outlet assembly 2, thus providing the user with flexible choices and a better product experience. In this embodiment, as the gear fixing plate 41 is arranged to seal the side opening 111 of the water flow-through cavity 11, the button fixing seat 51 is mounted on the gear fixing plate 41, and the rotation stopping pin 53 is movably and sealingly arranged on the gear fixing plate 41 in a penetrating manner.

In some embodiments of the control assembly 5, an upper surface of the rotation stopping protrusion 31 is an inclined surface 311, and the inclined surface 311 is inclined towards the end surface of the impeller 3 along a circumferential direction of the impeller 3. By providing the inclined surface 311, when the user presses the button 52 to push the rotation stopping pin 53 to abut against the inclined surface 311, the impeller 3 can still continue to rotate until the rotation stopping pin 53 abuts against the side surface of the rotation stopping protrusion 31.

In some embodiments of the control assembly 5, an inner wall of the moving channel 511 is repeatedly provided with a plurality of sets of structures, with each set of structures comprising a long groove 512, a short groove 513 and a first unidirectional tooth 514; a circumferential surface of the button 52 is provided with guiding protrusions 521 which are slidably engaged in the long grooves 512, such that the button 52 can axially move in the moving channel 511 without rotating, and an end surface of the button 52 facing the rotation stopping pin 53 is provided with a plurality of bidirectional teeth 522; a circumferential surface of the rotation stopping pin 53 is provided with limiting protrusions 531 which are slidably engaged in the long grooves 512 or the short grooves 513, and an end surface of the rotation stopping pin 53 facing the button 52 is provided with a plurality of second unidirectional teeth 532 which are arranged at equal angular intervals. The click-pen mechanism 5a is formed by the long grooves 512, the short grooves 513, the first unidirectional teeth 514, the guiding protrusions 521, the bidirectional teeth 522, the limiting protrusions 531 and the second unidirectional teeth 532, which is a typical retractable ball-point pen mechanism. Each time the button 52 is pressed, the rotation stopping pin 53 is driven to rotate by the bidirectional teeth 522 abutting against the second unidirectional teeth 532, and after rotating, the limiting protrusion 531 of the rotation stopping pin 53 is guided by the first unidirectional teeth 514 to be engaged in either the long grooves 512 or the short grooves 513, as the long grooves 512 and the short grooves 513 have different depths, the axial position of the rotation stopping pin 53 in the moving channel 511 is changed. In this embodiment, the rotation stopping pin 53 is composed of a pin shaft 53a and a movable part 53b, which are designed separately; the limiting protrusions 531 and the second unidirectional teeth 532 are both arranged on the movable part 53b, a limiting plate 533 is arranged on an end portion of the pin shaft 53a opposite to the movable member 53b, and the movable part 53b and the reset spring 54 are located on two sides of the limiting plate 533, respectively. As the movable part 53b is designed separately from the pin shaft 53a, a rotation torque force generated when the rotation stopping pin 53 is driven is not transmitted to the pin shaft 53a, such that the rotation of the movable part 53b is smoother. In other embodiments, the rotation stopping pin 53 may be an integral part.

In some embodiments of the control assembly 5, a circular gasket 55 is arranged on an inner end of the moving channel 511, and the rotation stopping pin 53 penetrates through the circular gasket 55 into the water flow-through cavity 11. In this embodiment, a V-ring is provided between the rotation stopping pin 53 and the circular gasket 55.

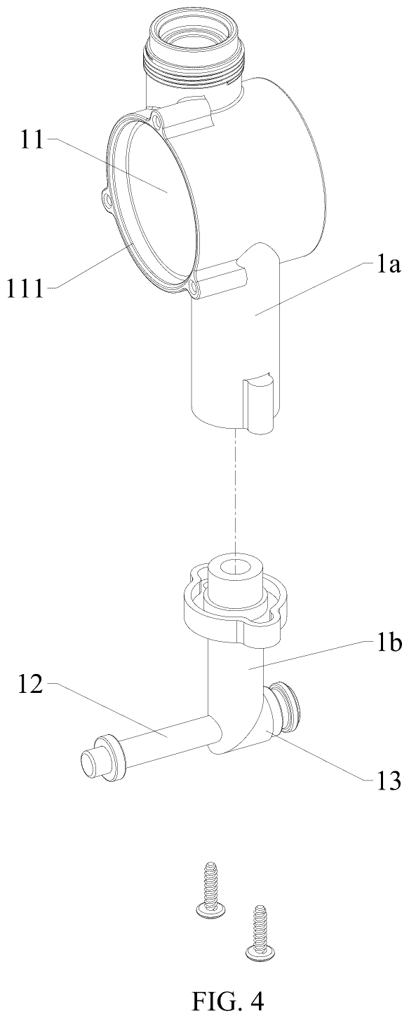

Referring to FIG. 4, the water flow-through part 1 comprises a water inlet body 1a and a water outlet body 1b, which are designed separately; the water flow-through cavity 11 is arranged in the water inlet body 1a; a lower end of the water outlet body 1b is provided with a rotating shaft 12 and a water outlet pipe 13 which are coaxially arranged; two sides of the upper surface of the water outlet assembly 2 are rotatably engaged on the rotating shaft 12 and the water outlet pipe 13, respectively, and two ends of the water outlet pipe 13 communicate with the water flow-through cavity 11 and the water outlet assembly 2. The water outlet pipe 13 is used as a water path communicating part and a rotating shaft of the water outlet assembly 2, and has multiple functions, such that the product has a simpler and more compact structure and is small in size.

The present invention further comprises a ball joint 6 mounted at a water inlet end of the water flow-through part 1, such that the product of the present invention not only can automatically swing the water outlet assembly 2 when water enters, but also can more flexibly adjust an initial orientation of the water outlet assembly 2 according to the user requirements. In addition, the water inlet end of the water flow-through part 1 is in threaded connection to a nut 7, and a round ball portion of the ball joint 6 is located in the nut 7 and limited by a clamping ring 8.

The present invention further comprises a housing 9 surrounding the water flow-through part 1 and the water outlet assembly 2, and the housing 9 is provided with two portions, namely a left housing and a right housing, which make the appearance of the product more concise.

The above embodiments and illustrations are not intended to limit the form and style of the product of the present invention. Any appropriate variations or modifications made by those of ordinary skills in the art within the scope of the present invention shall be considered as falling within the scope of the patent.

What is claimed is:

1. An auto-swinging shower comprising:
a water flow-through part, a water outlet assembly, an impeller and a transmission assembly;
the water flow-through part is provided with a water flow-through cavity;
a water inlet end of the water outlet assembly is pivotally engaged with a water outlet end of the water flow-through part and communicates with the water flow-through cavity;
the impeller is rotatably engaged in the water flow-through cavity;
an input end of the transmission assembly is in transmission connection to a rotating shaft of the impeller; an output end of the transmission assembly is in transmission connection to the water outlet assembly for driving the water outlet assembly to swing around a pivot shaft between the water outlet assembly and the water flow-through part.

2. The auto-swinging shower of claim 1, wherein the transmission assembly comprises a gear fixing plate, a gear shaft, a gear cover, and an output gear; the gear fixing plate is fixedly connected to the water flow-through part and seals a side opening of the water flow-through cavity; the gear shaft is movably and sealingly arranged on the gear fixing plate in a penetrating manner and is in key connection to the impeller; the gear cover is arranged parallel to the gear fixing plate and is fixedly connected to the gear fixing plate; the output gear is rotatably engaged between the gear fixing plate and the gear cover and is in transmission connection to the gear shaft; a transmission rod is arranged on the output gear; a protrusion is arranged on the water outlet assembly at a side of the output gear; a stadium-shaped hole is formed on the protrusion, and the transmission rod is movably engaged in the stadium-shaped hole.

3. The auto-swinging shower of claim 2, wherein the transmission assembly further comprises a plurality of transmission gears arranged between the gear fixing plate and the gear cover and in transmission connection between the gear shaft and the output gear.

4. The auto-swinging shower of claim 2, wherein the protrusion is a block-shaped part independently mounted on an upper surface of the water outlet assembly.

5. The auto-swinging shower of claim 2, wherein a convex ring is formed on a surface of the gear fixing plate facing the water flow-through part; the convex ring is embedded in the side opening of the water flow-through cavity, and a sealing ring is provided between a circumferential surface of the convex ring and an inner wall of the side opening; a V-ring is provided between the gear fixing plate and the gear shaft.

6. The auto-swinging shower of claim 2, wherein a notch is formed on the gear cover for movable engagement of the transmission rod.

7. The auto-swinging shower of claim 1, wherein it further comprises a control assembly; the control assembly comprises a button fixing seat, a button, a rotation stopping pin, and a reset spring; a rotation stopping protrusion is arranged on an end surface of the impeller; the button fixing seat is relatively fixed with the water flow-through part and is provided with a moving channel; the button is telescopically engaged at an outer end portion of the moving channel; the rotation stopping pin is engaged in an inner end portion of the moving channel in an axially movable manner, and movably and sealingly penetrates into the water flow-through cavity and abuts against the end surface of the impeller; as the impeller rotates, the rotation stopping pin movably abuts against a side surface of the rotation stopping protrusion; the reset spring drives the rotation stopping pin to move in a direction away from the impeller; a click-pen mechanism is arranged among the button fixing seat, the button and the rotation stopping pin.

8. The auto-swinging shower of claim 7, wherein an upper surface of the rotation stopping protrusion is an inclined surface, and the inclined surface is inclined towards the end surface of the impeller along a circumferential direction of the impeller.

9. The auto-swinging shower of claim 7, wherein an inner wall of the moving channel is repeatedly provided with a plurality of sets of structures, with each set of structures comprising a long groove, a short groove and a first unidirectional tooth; a circumferential surface of the button is provided with guiding protrusions which are slidably engaged in the long grooves, and an end surface of the button facing the rotation stopping pin is provided with a plurality of bidirectional teeth; a circumferential surface of the rotation stopping pin is provided with limiting protrusions which are slidably engaged in the long grooves or the short grooves, and an end surface of the rotation stopping pin facing the button is provided with a plurality of second unidirectional teeth which are arranged at equal angular intervals; the rotation stopping pin is composed of a pin shaft and a movable part which are designed separately; the limiting protrusions and the second unidirectional teeth are both arranged on the movable part; a limiting plate is arranged on an end portion of the pin shaft opposite to the movable member, and the movable part and the reset spring are located on two sides of the limiting plate respectively; the click-pen mechanism is formed by the long grooves, the short grooves, the first unidirectional teeth, the guiding protrusions, the bidirectional teeth, the limiting protrusions and the second unidirectional teeth.

10. The auto-swinging shower of claim 1, wherein the water flow-through part comprises a water inlet body and a water outlet body which are designed separately; the water flow-through cavity is arranged in the water inlet body; a lower end of the water outlet body is provided with a rotating shaft and a water outlet pipe which are coaxially arranged; two sides of an upper surface of the water outlet assembly are rotatably engaged on the rotating shaft and the water outlet pipe respectively, and two ends of the water outlet pipe communicate with the water flow-through cavity and the water outlet assembly.
